(19) United States
(12) Patent Application Publication
(10) Pub. No.: US 2007/0029756 A1
(43) Pub. Date: Feb. 8, 2007

(54) Trailer hitch

(76) Inventor: Craig D. Quargerg, Monticello, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 11/439,109

(22) Filed: May 23, 2006

Related U.S. Application Data
(60) Provisional application No. 60/684,363, filed on May 25, 2005.
(60) Provisional application No. 60/693,349, filed on Jun. 23, 2005.
(60) Provisional application No. 60/703,481, filed on Jul. 28, 2005.

(51) Int. Cl. B60D 1/44

(52) U.S. Cl. 280/447

(57) ABSTRACT

A swinging trailer to facilitate connection to a towed vehicle by placing the hitch ball carried by the towing vehicle and the hitch receiver carried by the towed vehicle in the view of the driver allowing the driver to better position the hitch ball in alignment with the trailer's ball receiver. The trailer hitch comprises a foldable linkage whose unfolded or extended length is greater than one-half the width of the towing vehicle. The foldable linkage is affixed to a post that is adapted to fit into the conventional hitch receiver secured to the frame of the towing vehicle the hitch ball is mounted at the free end of the foldable linkage. When the foldable linkage is in its fully folded state, the hitch ball is located immediately in front of the hitch receiver at the midline of the towing vehicle and when fully extended is outboard of the driver's side of the towing vehicle.

### CROSS REFERENCE TO RELATED APPLICATIONS

This application claims priority to Provisional Applications Ser. No. 60/684,363, filed May 25, 2005; Ser. No. 60/693,349, filed Jun. 23, 2005; and Serial No. 60/703,481, filed July 28, 2005, all of which are hereby incorporated by reference.

### BACKGROUND OF THE INVENTION

I. Field of the Invention

This invention relates generally to trailer hitches for motor vehicles, and more particularly to an improved design of a ball and ball socket-type trailer hitch that allows a driver to view both the ball carried by the towing vehicle and the socket on the tongue of the towed trailer to facilitate alignment of the two for hook-up of the trailer to the towing vehicle.

### I. Discussion of the Prior Art

One common type of trailer hitch found on many motor vehicles comprises a relatively short receiver tube of rectangular cross-section that is welded by brackets to the frame of the towing vehicle proximate the center of the rear bumper. The receiver tube is adapted to receive therein a rectangular bar that has a ball member bolted to one end thereof. The rectangular bar carrying the ball is held in place in the tubular receiver by a transversely-extending removable pin that passes through aligned apertures formed through the sidewalls of the tubular receiver and through the bar on which the ball is mounted. The bar projects outwardly beyond the rear bumper of the towing vehicle only about 8 to 10 in.

When it is desired to hitch the towing vehicle to a trailer, the trailer must either be manually moved to a point where the ball socket on the trailer is brought into alignment with the ball on the hitch and lowered onto the ball. A knob on the socket is then turned to bring a latch member into engagement with a neck that connects the ball to the rectangular bar on which the ball is mounted. However, with heavy trailers, such as those used to transport a boat or other heavy loads, it is often not possible to manually move the trailer and, thus, it becomes necessary to back the towing vehicle to a precise point where the socket on the trailer is vertically aligned with the ball on the vehicle's trailer hitch. When it is recognized that the trailer hitch only extends about 10 in. beyond the rear bumper at the center thereof, it cannot be viewed by the driver using the rear-view mirror of the vehicle. Hence, maneuvering the towing vehicle becomes a hit or miss proposition. Even with another person providing guiding directions, getting the hitch accurately aligned with the socket on the trailer to be towed is time consuming and frequently results in damage to the towing vehicle caused by the socket on the trailer tongue striking the vehicle's bumper or sheet metal at the rear of the vehicle.

It can be seen, then, that a need exists for a trailer hitch arrangement that will allow the vehicle driver to readily observe the ball on the trailer hitch and the socket portion of the hitch that is on the trailer itself through the vehicle's driver side rear view mirror. The present invention fulfills such a need.

### SUMMARY OF THE INVENTION

The trailer hitch of the present invention includes a short post or bar of rectangular cross-section adapted for insertion into the tubular receiver affixed to the frame of the towing vehicle proximate a centerline of the rear bumper. Instead of having the short rectangular post directly support the hitch ball as in the prior art, the post is welded to a relatively longer, three-sided, steel channel proximate one end of the channel. The channel is of U-shaped cross-section and is welded to the aforementioned post or bar such that the channel is open to the rear of the vehicle on which the hitch is used.

Pivotally joined to the channel at the opposed end portion thereof is a tubular bar of rectangular cross-section that is dimensioned to allow it to be folded into and received within the open side of the U-shaped channel. Thus, the channel and the tubular bar form a foldable linkage. Welded to the end of the tubular bar opposite from the pivot is a further tubular receiver of rectangular cross-section, having the open center portion or lumen thereof oriented vertically. This tubular receiver is arranged to receive a rectangular post that supports a flat steel bar to which the hitch ball member is bolted. The rectangular post includes a plurality of apertures extending laterally through it so that a pin can be passed through the tubular receiver and through a selected one of the vertically spaced holes to provide adjustability to the height of the ball above ground surface.

The length of the channel and the bar that can pivot into the channel are such that when the bar is swung out from the channel, the ball hitch member extends laterally beyond the side of the vehicle and is, therefore, viewable by the driver either directly or by using a rear view mirror mounted on the driver's side of the towing vehicle. When in this position, the driver may view the scene as he or she backs the vehicle until the ball is directly beneath the ball receiving socket on the trailer to be towed. The trailer tongue can then be lowered by manipulating the trailer jack so that the ball falls into the ball receiving socket and, at this point, the screw knob on the trailer socket can be turned to bring the socket's latch member into engagement with the neck formed on the ball member.

Next, by slowly driving forward, the bar to which the ball assembly is affixed will pivot about the hinge pin that connects it to the channel allowing the bar to again deploy and become latched within the channel and, at this point, the ball hitch is again aligned with the centerline of the towing vehicle. Next, a pin is inserted through aligned apertures in the channel and in the end of the elongated bar, thereby holding the bar within the laterally extending channel.

### DESCRIPTION OF THE DRAWINGS

The foregoing features, objects and advantages of the invention will become apparent to those skilled in the art from the following detailed description of a preferred embodiment, especially when considered in conjunction with the accompanying drawings in which:

FIG. 1 is a pictorial view of a first embodiment showing the trailer hitch of the present invention in its extended state;

FIG. 2 is a perspective view of the trailer hitch of FIG. 1 in its partially folded state;

FIG. 3 is a perspective view of the trailer hitch of FIG. 1 in its fully folded state;

FIG. 4 is a view affording a perspective view of the trailer hitch in its folded state and with the support wheel in its stowed position;

FIG. 5 is an alternative embodiment of the trailer hitch of the present invention having dual folding arms;

FIG. 6 illustrates the addition of a latch mechanism to the embodiment of FIG. 5; and

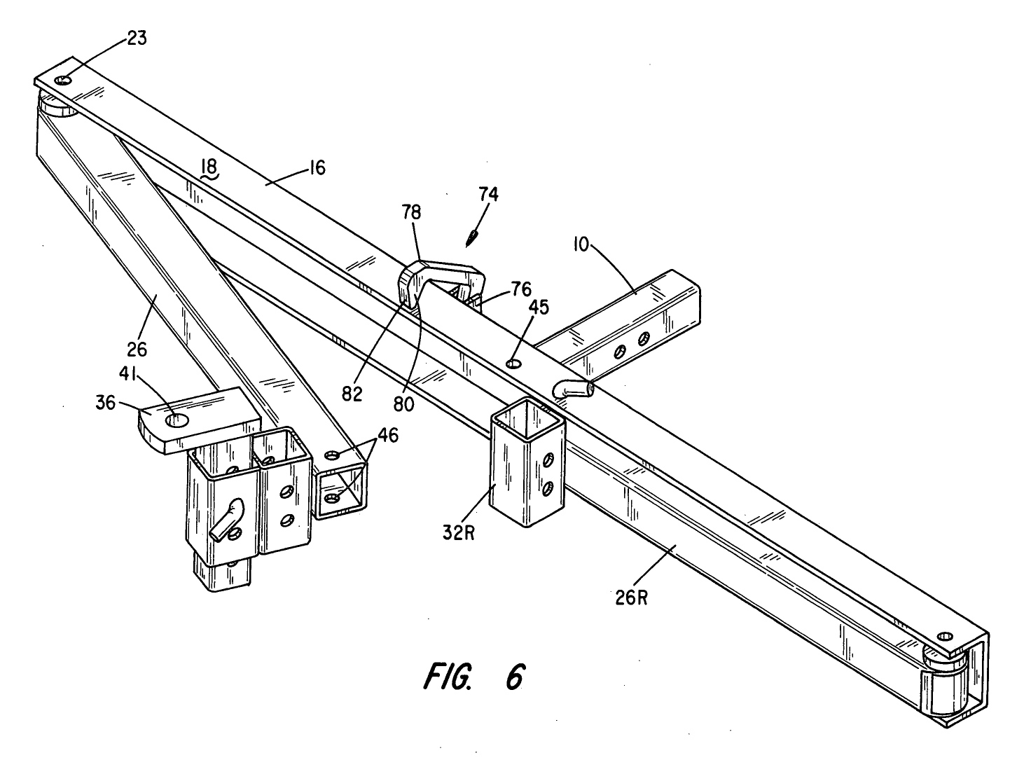

FIG. 7 illustrates the latch mechanism engaging the swing arm 26 to hold it in the channel 16.

### DESCRIPTION OF THE PREFERRED EMBODIMENT

Certain terminology will be used in the following description for convenience in reference only and will not be limiting. The words “upwardly”, “downwardly”, “rightwardly” and “leftwardly” will refer to directions in the drawings to which reference is made. The words “inwardly” and “outwardly” will refer to directions toward and away from, respectively, the geometric center of the device and associated parts thereof. Said terminology will include the words above specifically mentioned, derivatives thereof and words of similar import.

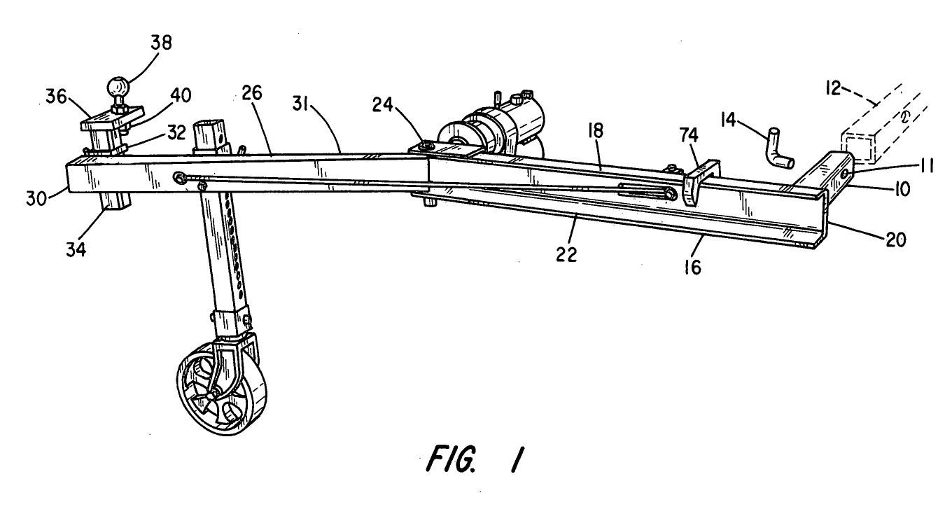

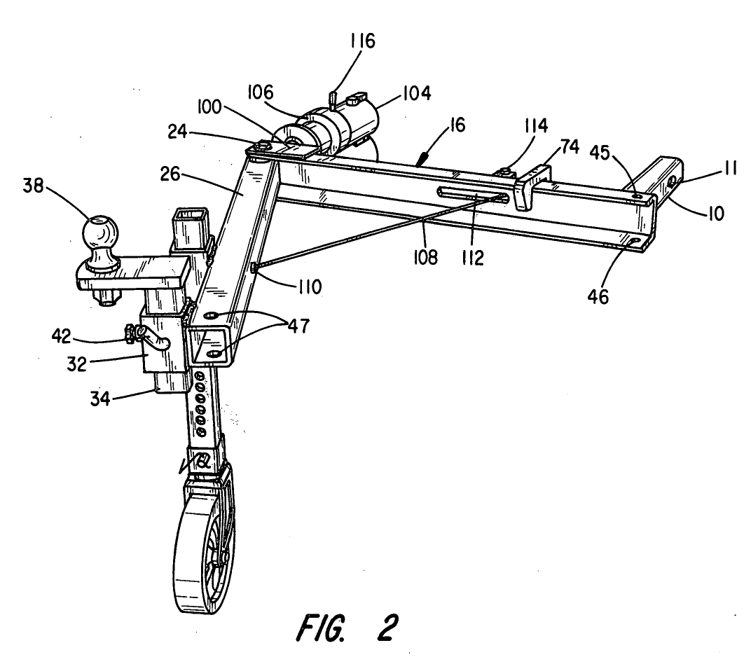

Referring first to FIGS. 1 and 2, the trailer hitch of the present invention is seen to comprise a post 10 that is adapted to be inserted into a hitch receiver 12 of conventional design found on many motor vehicles. The post 10 has a hole 11 formed through it from its right side to its left side and which can be aligned with holes formed through the opposed sides of the receiver 12 allowing a pin 14 to be inserted through the aligned holes to hold the post 10 in place.

The post 10 is welded to an elongate channel member 16 having a top side 18, a rear side 20 and underside 22 and an open front side. The steel channel member 16 is of a length that is greater than ¼th of width of the towing vehicle and formed through the upper side wall 18 and the lower side wall 22 proximate the leftmost end thereof when viewed in FIG. 1 are aligned holes, allowing a hinge pin 24 to be inserted through them and through aligned apertures formed in the rightmost end of an extension bar 26.

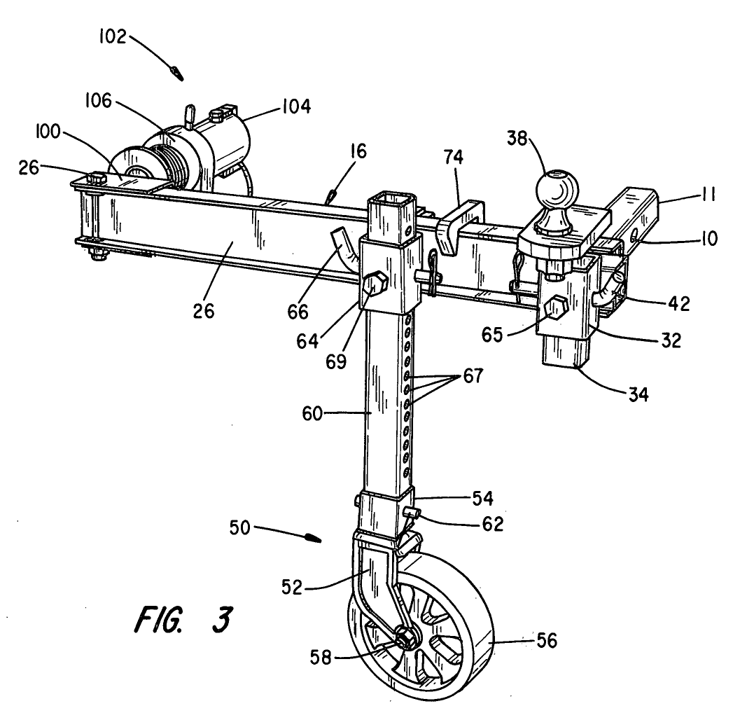

The extension bar may be solid, but preferably comprises a tube of rectangular cross-section where the height dimension of the bar 26 allows it to be folded within the open front side of the channel member 16, as best seen in the view of FIG. 3.

The combined length of the channel 16 and the bar 26 are such that the left end 30 of the bar 26 extends laterally beyond the left side edge of the towing vehicle on which the hitch assembly is attached. Welded to a rear surface 31 of the bar 26 proximate its left end 30, when viewed in FIG. 1 is a tubular receiver 32 of rectangular cross-section allowing a rectangular post 34 of lesser dimension to fit therein. Welded to the top of the post 34 is a plate 36 to which a conventional hitch ball assembly 38 may be attached by means of a bolt with a nut 40 passing through an aperture 41 in the plate 36.

Because the combined length of the channel member 16 and the pivotable bar 26 is greater than one-half the width dimension of the towing vehicle, the ball assembly 38 can be viewed by the vehicle's driver through the driver's side rear view mirror (not shown). The height above ground of the ball 38 is adjustable, within limits, by providing a series of aligned apertures along the length dimension of the post 34, one of which is selected for insertion of a pin 42 that extends through aligned apertures 33 in opposed sides of the tubular receiver 32.

With special reference to FIG. 3, when the bar 26 is rotated into the confines of the channel member 16, a third pin (not shown) may be dropped through aligned apertures 45 and 46 formed vertically through the right end portion of the channel member and apertures 47 in the outer end portion 30 of the bar 26, respectively, thus preventing the bar 26 carrying the hitch ball 38 from swinging out from the confines of the channel 16.

In operation, when desiring to hook up to a trailer, the pin (not shown) will be pulled from the apertures 45-47 and the bar 26 swung out from the confines of the channel 16 to the position shown in FIG. 1. At this point, the ball 38 will be visible to the vehicle's driver either through the driver's side rearview mirror or by the driver leaning out the vehicle's window while looking rearward. He or she may now back the vehicle to the point where the hitch ball 38 is directly beneath the socket on the tongue of the trailer to be towed. At this point, the driver will leave the vehicle and manipulate a trailer jack on the trailer's tongue to lower the ball receiving socket portion of the hitch onto the ball 38. Once the socket is secured to the ball 38, the driver may pull forward slightly resulting in the bar 26 pivoting about the pin 24 through a predetermined arc. Then, by backing up slightly, the hitch will reach the disposition shown in FIG. 3. At this point, the pin may be re-inserted through holes 45-47, holding the hitch ball 38 in direct alignment with the post 10 and the receiver 12. At this point, the trailer is ready to be towed.

Referring again to FIG. 2, as an option, there may be included a winch assembly for effecting closure of the bar 26 within the channel 16 following the coupling of the trailer's hitch socket to the hitch ball 38. The use of the winch assembly obviates the need for performing the described driving maneuver to effect closure of the bar 26 within the channel 16.

The winch assembly comprises a C-shaped winch mounting bracket 100 secured to the channel 16 by the hinge pin 24. Bolted to the mounting plate is a commercially-available winch 102 having a d.c. motor 104 driving a spool 106 on which a steel cable 108 is wound. The free end of the cable 108 has a hook (not shown) that engages the edge of a slot 110 formed in the rear surface of the bar 26. The cable also passes through a slot 112 formed through the back surface 20 of the channel 15 and about a vertically oriented guide roller 114, only a top portion thereof can be seen in FIG. 2. The d.c. motor 104 is adapted to be powered by the battery of the towing vehicle.

The winch has a clutch lever 116 that, when moved in a first direction. disengages the spool allowing the bar 26 to be freely manually moved to its fully extended position as in FIG. 1. When the clutch lever 116 is moved to a second position and the motor 104 is actuated, the cable 108 is wound onto the spool 105 as the bar 26 to which the towed vehicle is now coupled is drawn into the confines of the channel 16.

Should a difficulty arise in attempting to couple the socket portion of a trailer hitch onto the ball 38 due to deflection of the channel 16 and the extended pivotal bar 26 because of the weight of the trailer tongue, there is provided a support wheel assembly 50 that is attachable to the outer end portion of the tubular bar 26. More particularly, and with reference to FIG. 3, the support wheel assembly 50 is seen to comprise a caster wheel having a yoke 52 that is journaled for rotation about a vertical shaft (not shown). A wheel member 56 is mounted on an axel 58 supported by the yoke 52. The vertical shaft fits into a cylindrical socket 54 surrounding a lower end of a tubular post 60 and is held in place by a pin 62. The post 60 is inserted through a tubular receiver 64 of rectangular cross-section welded to the front side surface of bar 16. A pin 66 extends through aligned bores in opposed walls of the receiver 64 and a selected one of the plurality of apertures 67 in post 60 to lock the wheel assembly at a desired elevation that will maintain the bar 26 level when fully extended.

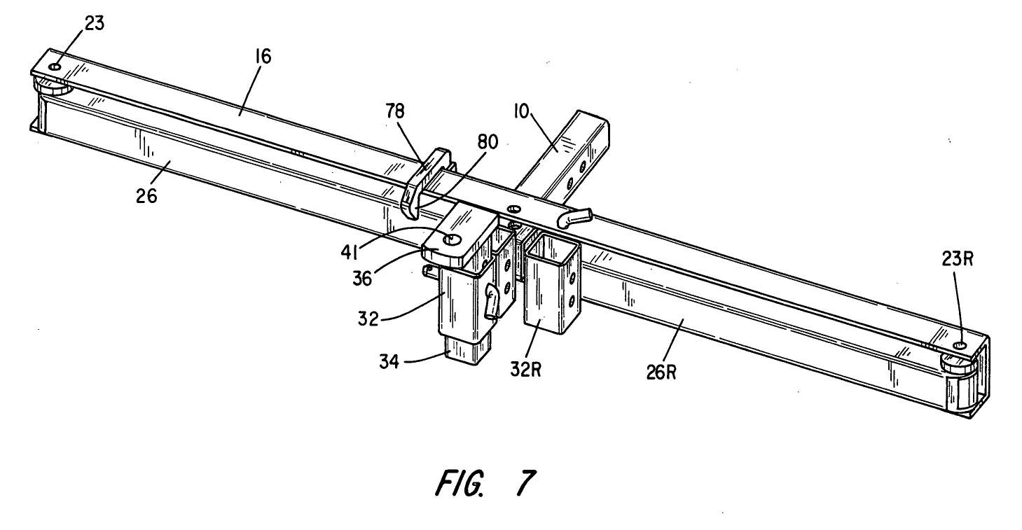

As can be seen from FIG. 7, the wheel assembly 50 engages the ground and prevents deflection of the hitch ball 38 as the trailer's tongue weight is applied to the extended arm 26.

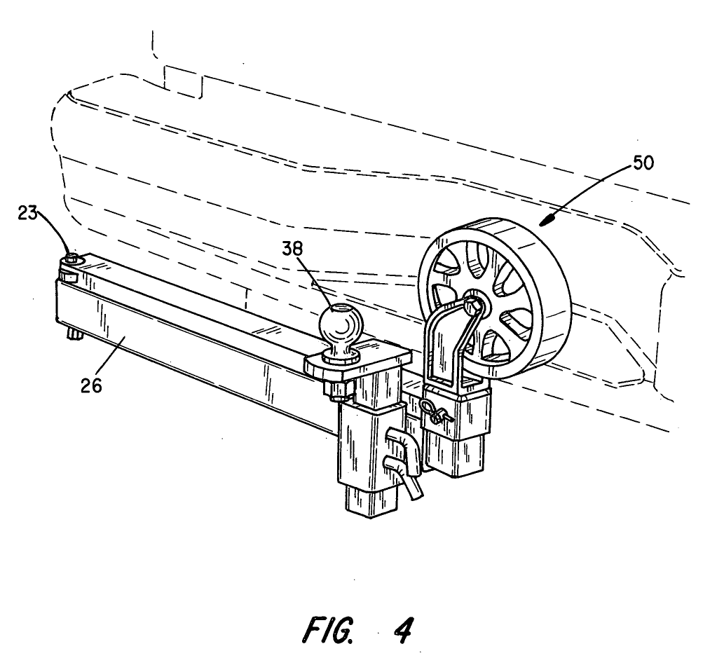

Next, with reference to FIG. 4, the wheel assembly 50 can be stowed when not in use by simply pulling the pin 66, removing the post 60 from the lumen of the receiver 64, rotating the assembly by 1800 and reinserting the post 60 into the upper end of the receiver 64, such that the wheel 56 extends upward as shown.

Without limitation, the channel 16 may be square and approximately 4 in. on a side. Its length may be about 26 in. The bar 26 may also be of rectangular cross-section measuring about 3.5 in. on a side and may also be 26 in. in length. While the post 10 and the receiver 32 are preferably welded to the channel 16 and the bar 26, respectively, it is also possible to use bolts to fasten the aforementioned parts to one another. To eliminate any play between the receiver 32 and post 34 and between receiver 64 and post 67 that might result in a rattling noise, it has been found convenient to weld a nut about an aperture drilled through the receivers and then inserting set-screws 65 and 69 that urge the posts securely against the inside wall of the receivers.

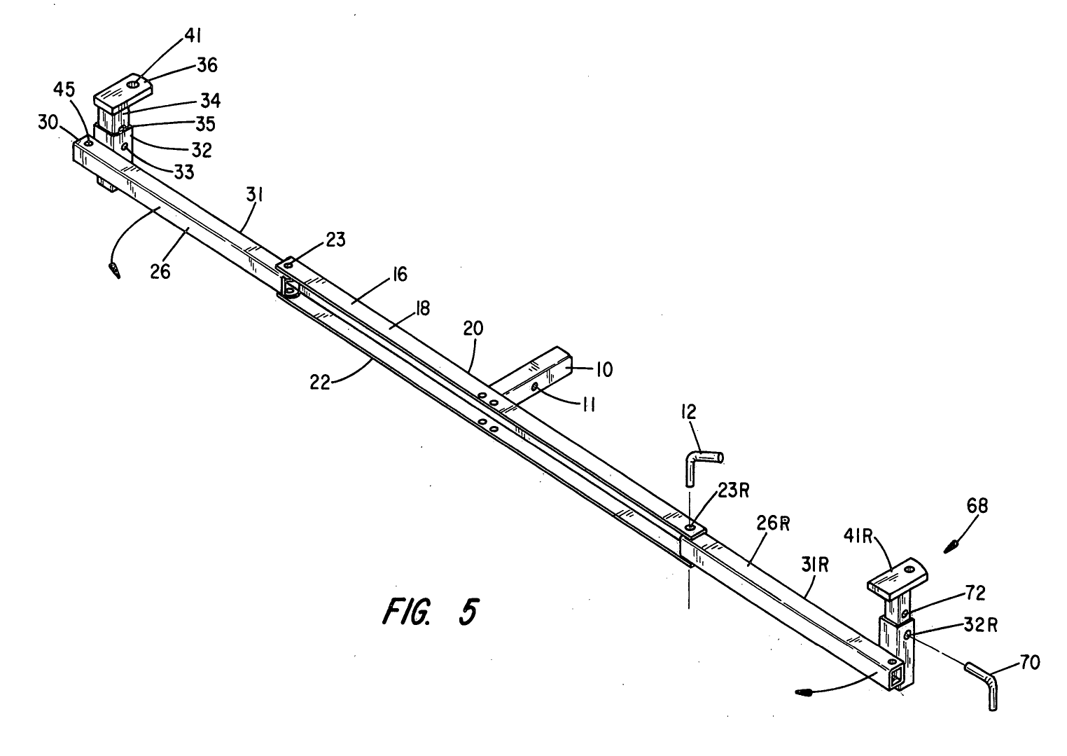

FIG. 5 illustrates an alternative embodiment of the invention. In the embodiment of FIG. 5, the channel 16 is made double the length of that depicted in the embodiment of FIGS. 1-3 and with the post 10 welded to the elongated channel 16 at its approximate midpoint. Then, not only is a tubular bar 26 pivotally connected to the left end of the channel 16, but a further tubular arm 26R is pivotally connected to the rightmost end of the channel 26 by a hinge pin 71 that extends through aligned apertures 23R formed through the channel 16 and the left end portion of the bar 26R.

The width dimension and height dimension of the bar 26R are such that the bar 26R will fold into the space between the upper sidewall 18 and the lower sidewall 22 of the channel member 16. The tubular bar 26R has a relatively short length of tubular bar stock 32R welded to the rear wall 31R proximate the right end thereof for accommodating an insert member 68 therein. A pin 70 inserted through aligned bores in the tube stock 32R and the post of the insert member 68 is used to maintain the insert member 68 at a selectably adjustable elevation determined by a series of bores formed through the post of the insert member 68. Only one such bore 72 is visible in the view of FIG. 5. Hitch ball 38 is preferably attached to the plate 41 so that when arm 26 is extended, it will be viewable by the driver. The other insert member 41R may then be used as a place to affix a variety of possible attachments, e.g., a barbeque grill for camping or for tailgating at sporting events, a bike carrier, a luggage rack, a spare trailer tire, etc. Because of the manner in which the arms 26 and 26R swing out and away from the rear of the towing vehicle, such attachments do not inhibit the ability to open rear doors of a panel truck or van nor does it interfere with the lifting of a tailgate on SUV on which the trailer hitch of the present invention may be used.

It has also been found advantageous to add a latch assembly 74 to the hitch of the present invention to facilitate capture of the swing arm 26 in the channel 16 during the hook-up of the trailer to the towing vehicle. As explained at page 5, once the trailer hitch socket on the trailer is secured to the ball 38, the driver will pull forward slightly and that results in the bar 26 pivoting about pin 24 and swinging through a predetermined arc. Then, by backing up slightly, the swing bar 26 will fold into the channel and at this point the driver must leave his vehicle and insert the pin 44 through the holes 45 and 46. However, it has been found that if the trailer is on a slight incline, it may want to coast rearward due to gravity so that the arm 26 will again swing out slightly so that the apertures 45 and 46 will no longer be aligned to permit a pin to be dropped there through. The addition of the latch assembly 74 solves this problem.

As shown in FIG. 5, the latch assembly 74 comprises a clevis-type bracket 76 that is welded or otherwise affixed to the rear face surface of the channel 16, and a C-shaped latch 78 is pivotally joined to the clevis by a hinge pin (not shown). The hook portion 80 of the latch 78 is spaced sufficiently from its hinge pin so as to straddle the top 18 of the channel 16 with the hook portion 80 residing in front of the open face of the channel 16. It is further noted that the hook portion 80 has a tapered profile 82 on a front face surface thereof that acts as a cam. As the swing bar 26 moves against this tapered surface 82, it causes the latch 78 to first rise and then it subsequently falls as the swing arm 26 completely enters the channel 16 clearing the hook 80. As best seen in FIG. 12, the latch 78 with its depending hook portion 80 will retain the swing arm 26 within the channel until such time that the driver inserts a locking pin down through the now-aligned apertures 45 and 46. Thus, even if the trailer is on a slight incline, once the swing bar 26 is made to fully enter the channel 16, it cannot again pull out so that the apertures 46 are no longer aligned with the apertures 45.

The addition of the hook assembly also provides added safety in the highly unlikely event that the pin used to secure the swing bar 26 in the channel 16 may be jarred free from its locking position due to ground irregularities encountered in travel. Here, the latch would continue to hold the swing bar in the channel with the hitch bar 38 aligned with the post 10.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A trailer hitch assembly comprising:
(a) a first post member adapted for insertion into a hitch receiver on a towing vehicle;
(b) an elongated, U-shaped channel affixed to an end of the post member and extending perpendicularly thereto;
(c) a bar member pivotally coupled about a vertical axis to one end of the elongated channel where the bar member can be pivoted so as to either be contained within the U-shaped channel or to swing through an arc of up to 1800 from said one end, the combined length of the channel and the bar member when the bar member is fully extended being greater than the distance between the hitch receiver and a side panel of the towing vehicle;
(d) a tubular receiver affixed to the bar member at an end opposite the pivotal coupling; and
(e) a second post member insertable into the tubular receiver affixed to the bar member, the second post member supporting a hitch ball thereon.

2. The trailer hitch assembly as in claim 1 wherein the elongated U-shaped channel is affixed to the first post member by welding.

3. The trailer hitch assembly as in claim 1 wherein the bar member comprises steel tubing of a rectangular cross-section.

4. The trailer hitch assembly as in claim 1 wherein a depth of insertion of the second post member within the tubular receiver is vertically adjustable.

5. The trailer hitch assembly as in claim 1 and further including a ground-engageable structure attachable to the bar member at the end opposite the pivotal coupling.

6. The trailer hitch assembly as in claim 1 wherein the ground engaging structure comprises a caster wheel.

7. The trailer hitch assembly as in claim 6 wherein the bar member comprises steel tubing of a rectangular cross-section and the caster wheel is joined to a third post member, the post being dimensioned to fit within a lumen of the steel tubing.

8. The trailer hitch assembly as in claim 1 wherein the first post member is affixed to the elongated U-shaped channel proximate one end thereof.

9. The trailer hitch assembly as in claim 1 wherein the first post member is affixed to the elongated U-shaped channel proximate a midpoint of the elongated U-shaped channel.

10. The trailer hitch assembly as in claim 9 and further including a second bar member pivotally coupled to an end of the elongated U-shaped channel opposite to said one end.

11. A trailer hitch assembly comprising:
(a) a first post member adapted for insertion into a trailer hitch receiver of a towing vehicle;
(b) a ball member adapted for engagement by the ball clamp on a tongue of a towed vehicle; and
(c) a foldable linkage connected between the first post member and the ball member for controlling movement of the ball member from a first position closely adjacent the first post member to a second position outboard of a side panel of the towing vehicle.

12. The trailer hitch assembly of claim 11 wherein the ball member is viewable by a driver of the towing vehicle in a side mirror on the towing vehicle when the ball member is in the second position.

13. The trailer hitch assembly of claim 11 wherein the foldable linkage comprises:
(a) an elongated U-shaped steel channel of generally rectangular cross-section affixed to an end of the first post member; and
(b) a generally rectangular bar pivotally joined at one end to a first end of the channel and having the ball member coupled to the bar proximate a second end of the bar.

14. The trailer hitch assembly of claim 13 wherein the bar is pivotable about a vertical axis and is of a cross-sectional dimension allowing it to fit between opposed side walls of the U-shaped channel.

15. The trailer hitch assembly of claim 13 wherein the elongated U-shaped steel channel is affixed to one end of the first post member at a location proximate an end of said channel opposite said one end.

16. The trailer hitch assembly of claim 13 wherein the elongated U-shaped steel channel is affixed to the first post member at a location proximate a midpoint of said channel.

17. The trailer hitch assembly of claim 16 and further including a second generally rectangular bar pivotally jointed about a vertical axis proximate said first end thereof, the second bar being dimensioned to fit between said opposed sides of the U-shaped channel.

18. The trailer hitch assembly of claim 13 wherein the channel and the bar are of generally equal length.

19. The trailer hitch assembly of claim 17 wherein the channel is about twice the length of the first and second bars.

20. The trailer hitch assembly of claim 11 and further including a motor powered winch operatively coupled to the foldable linkage for moving the ball member from the second position to the first position.

21. The trailer hitch assembly of claim 13 and further including a motor driven winch affixed to the U-shaped channel, the winch having a cable with an end thereof coupled to the generally rectangular bar at a location longitudinally offset from the one end of the bar.
